(19) United States
(12) Patent Application Publication
(10) Pub. No.: US 2026/0118926 A1
(43) Pub. Date: Apr. 30, 2026

(54) BEZEL HEALTH MANAGEMENT

(71) Applicant: Dell Products L.P., Round Rock, TX (US)

(72) Inventors: Parminder Singh SETHI, Punjab (IN); Pandiyarajan MANI, Gudiyattam (IN); Swaminathan TA, Bangalore (IN); Akbar SHERIFF, Salem (IN); Nishant SINGH, Kanpur (IN)

(73) Assignee: Dell Products L.P., Round Rock, TX (US)

(21) Appl. No.: 18/929,303

(22) Filed: Oct. 28, 2024

(51) Int. Cl. G06F 1/20

(52) U.S. Cl. CPC G06F 1/20

(57) ABSTRACT

An information handling system may include a chassis and a plurality of host information handling systems disposed within the chassis. Each host information handling system may include a host processor, an air mover, and an air filter. A particular one of the plurality of host information handling systems may further include an airflow sensor configured to detect an amount of airflow associated with the air mover of the particular host information handling system, but none of the other host information handling systems include corresponding airflow sensors. In response to an airflow reading from the airflow sensor indicating that the air filter of the particular host information handling system is clogged, the information handling system is configured to: raise an air filter warning on the particular host information handling system; and raise an air filter warning on the other host information handling systems.

### TECHNICAL FIELD

The present disclosure relates in general to information handling systems, and more particularly to management of system health and airflow.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Server information handling systems are sometimes organized as multiple hosts within a single chassis. Each host may include its own cooling hardware, such as air movers (e.g., fans or blowers), air filters, and airflow sensors to detect when the air filters are clogged.

In some instances, however, not every host in a given chassis may be equipped with every cooling component (e.g., for cost, space, or logistical reasons). For example, an airflow sensor may be integrated into an “active bezel” that may be affixed to the front of a host, and in some implementations, only one host within a chassis may include such an active bezel.

Accordingly, if there is an airflow issue (e.g., due to clogged air filters), then the system having the active bezel may experience a filter health warning, but that status may be reflected in only that single host. This is inconvenient, because it is likely that when one air filter in a chassis is clogged, the other air filters are also clogged.

Embodiments of this disclosure address this problem by proceeding on the assumption that, whenever the active bezel airflow sensor raises a warning, the other hosts in the chassis are likely in a similar condition. Thus the system may raise an airflow warning for all of the other hosts in the same chassis, even though they do not include airflow sensors.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with management of system health and airflow may be reduced or eliminated.

In accordance with embodiments of the present disclosure, an information handling system may include a chassis and a plurality of host information handling systems disposed within the chassis. Each host information handling system may include a host processor, an air mover, and an air filter. A particular one of the plurality of host information handling systems may further include an airflow sensor configured to detect an amount of airflow associated with the air mover of the particular host information handling system, but none of the other host information handling systems include corresponding airflow sensors. In response to an airflow reading from the airflow sensor indicating that the air filter of the particular host information handling system is clogged, the information handling system is configured to: raise an filter warning on the particular host information handling system; and raise an air filter warning on the other host information handling systems.

In accordance with these and other embodiments of the present disclosure, a method may include, in an information handling system that includes a chassis and a plurality of host information handling systems disposed within the chassis, each host information handling system including a host processor, an air mover, and an air filter, wherein a particular one of the plurality of host information handling systems further includes an airflow sensor configured to detect an amount of airflow associated with the air mover of the particular host information handling system, and wherein none of the other host information handling systems include corresponding airflow sensors: in response to an airflow reading from the airflow sensor indicating that the air filter of the particular host information handling system is clogged, raising an air filter warning on the particular host information handling system; and raising an air filter warning on the other host information handling systems.

In accordance with these and other embodiments of the present disclosure, an article of manufacture may include a non-transitory, computer-readable medium having computer-executable instructions thereon that are executable by an information handling system that includes a chassis and a plurality of host information handling systems disposed within the chassis, each host information handling system including a host processor, an air mover, and an air filter, wherein a particular one of the plurality of host information handling systems further includes an airflow sensor configured to detect an amount of airflow associated with the air mover of the particular host information handling system, and wherein none of the other host information handling systems include corresponding airflow sensors, the instructions being executable for: in response to an airflow reading from the airflow sensor indicating that the air filter of the particular host information handling system is clogged, raising an air filter warning on the particular host information handling system; and raising an air filter warning on the other host information handling systems.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of another example information handling system, in accordance with embodiments of the present disclosure;

FIG. 3 illustrates a block diagram of an example active bezel, in accordance with embodiments of the present disclosure; and

FIG. 4 illustrates an example method, in accordance with embodiments of the present disclosure.

### DETAILED DESCRIPTION

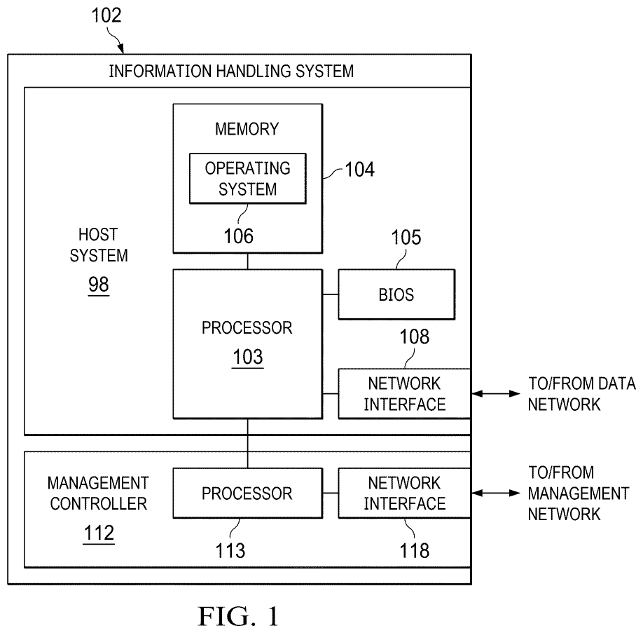

Preferred embodiments and their advantages are best understood by reference to FIGS. 1 through 4, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

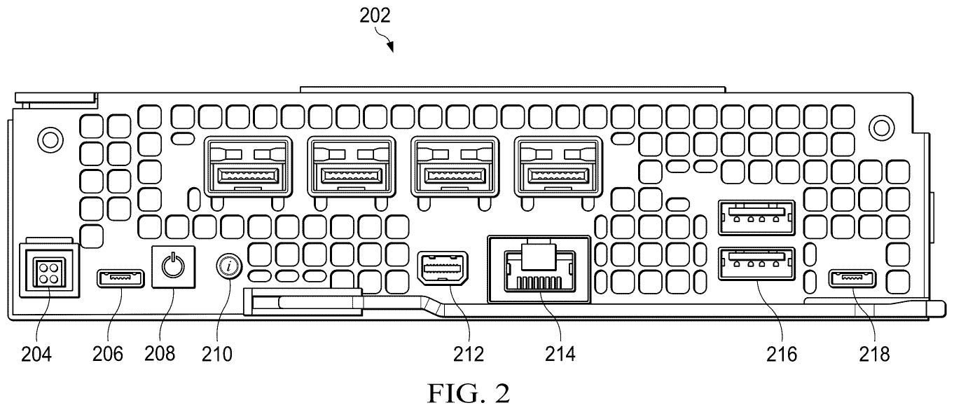

Turning now to FIG. 2, a front view of another example information handling system 202 is shown. Information handling system 202 is a rack-mount server system designed to be installed in a multi-host chassis.

Information handling system 202 includes various buttons and ports, such as USB ports 206, 216, and 218; power button 208; unit identifier button 210; display port 212; network port 214; etc. Information handling system 202 also includes an airflow sensor port 204, which may be used to couple to a corresponding connector on an active bezel.

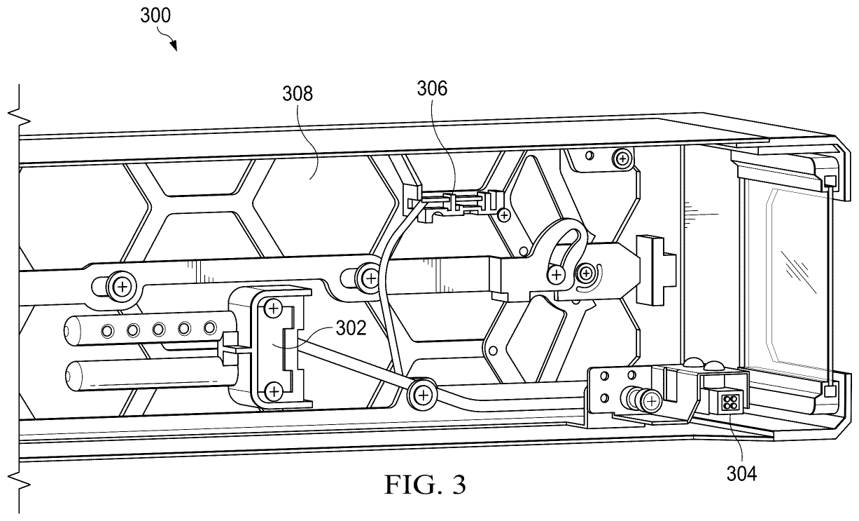

FIG. 3 shows active bezel 300, which can be attached to the front of information handling system 202. In particular, airflow sensor connector 304 may be mated with airflow sensor port 204 on information handling system 202. In one implementation, airflow sensor connector 304 may include several spring-loaded pogo pins, which may be pressed against conductive pads in airflow sensor port 204 when active bezel 300 is installed.

Active bezel 300 also includes an airflow sensor 302, which measures the airflow through filter 308 and is communicatively coupled to airflow sensor connector 304. Airflow sensor 302 may detect the presence or absence of filter 308, as well as its condition (clean or clogged). Filter 308 may be removed, replaced, and/or cleaned by the user as needed based on the signals from airflow sensor 302. Active bezel 300 may also include other components such as a display 306 for reporting system operational conditions, etc.

As noted above, in some implementations, only one information handling system 202 in a multi-host chassis may be fitted with an active bezel 300. Thus ordinarily the user may receive an airflow warning about only the one system that includes active bezel 300. If other information handling systems in the chassis are also experiencing airflow issues (which is likely, given that the hosts and/or the air filters may have been installed simultaneously), the user will not be notified about those issues.

Accordingly, embodiments of this disclosure may improve on this situation by transmitting information about an airflow warning to the other hosts in a chassis when the host with the active bezel detects a clogged air filter. For example, the host with the airflow sensor may directly contact the other hosts in the chassis. In other embodiments, the host with the airflow sensor may contact a management controller, which may then contact the other hosts in the chassis. The other hosts may then notify the user that they, too, are having airflow problems and need air filter service.

In one implementation, a service such as the avahi daemon may be used to transmit an alert to the other hosts in the chassis. That is, if any host's airflow problem is detected by the avahi service, then the service may communicate this alert to all other hosts in the chassis using their internal link-local addresses for security. Those other hosts may then also notify the user to check for clogged air filters in all hosts to protect those other hosts from airflow issues and overheating. For example, this notification may occur when the airflow sensor detects that the airflow has dropped below a designated threshold (e.g., 70% of the nominal airflow).

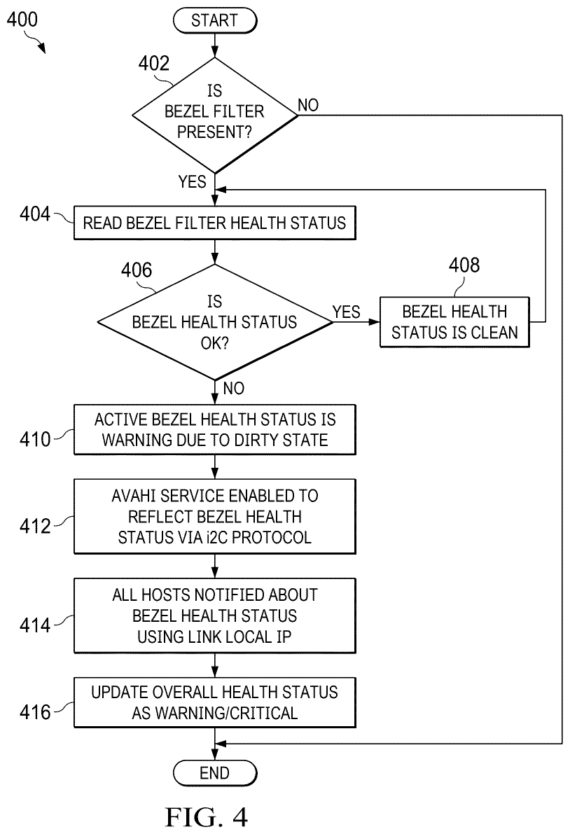

Turning now to FIG. 4, a flowchart of an example method 400 is shown, according to some embodiments.

At step 402, the system may check whether or not the bezel air filter and airflow sensor are present. If not, the method may end. This check may be repeated periodically (e.g., every 30 seconds) in some embodiments.

At steps 404 and 406, the system may obtain readings from the airflow sensor. If the air filter is clean and the airflow (or air pressure) readings are normal, the method may loop back at step 408 to continue taking readings periodically (e.g., every 5 minutes). For example, a reading of 75% or more of the nominal airflow may be considered a clean reading.

If the reading is between 70% and 75% of nominal, this may be considered a warning state. If the reading is below 70%, this may be considered a critical state. If either the warning state or the critical state occurs, at steps 410-412, the avahi service may initiate a notification that the air filter is dirty and in need of service.

At step 414, all of the other hosts in the chassis may receive the alert notification about this bezel health status via their link-local IP address. Based on the alert notification, all of the other hosts may update their own air filter health statuses accordingly to match the status from the one host that has the airflow sensor. In one embodiment, this update may be carried out using a protocol such as sailfish.

One of ordinary skill in the art with the benefit of this disclosure will understand that the preferred initialization point for the method depicted in FIG. 4 and the order of the steps comprising that method may depend on the implementation chosen. In these and other embodiments, the method may be implemented as hardware, firmware, software, applications, functions, libraries, or other instructions. Further, FIGURE although 4 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the method.

Thus embodiments may provide many benefits. For example, service cost may be reduced by avoiding unnecessary support visits for replacing air filters that do not yet need to be replaced. Further, system performance may be improved by preventing throttling. Further, air movers may be operated at optimal speeds instead of excessively high speeds when filters are clogged.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
a chassis; and
a plurality of host information handling systems disposed within the chassis, wherein each host information handling system includes:
a host processor;
an air mover; and
an air filter;
wherein a particular one of the plurality of host information handling systems further includes an airflow sensor configured to detect an amount of airflow associated with the air mover of the particular host information handling system, and wherein none of the other host information handling systems include corresponding airflow sensors; and
wherein, in response to an airflow reading from the airflow sensor indicating that the air filter of the particular host information handling system is clogged, the information handling system is configured to:
raise an air filter warning on the particular host information handling system; and
raise an air filter warning on the other host information handling systems.

2. The information handling system of claim 1, wherein the airflow sensor is disposed within a removable bezel of the particular information handling system.

3. The information handling system of claim 1, wherein the particular host information handling system is configured to notify the other host information handling systems directly regarding the air filter being clogged.

4. The information handling system of claim 1, wherein the airflow sensor is further configured to detect a missing air filter.

5. The information handling system of claim 1, wherein the particular host information handling system is configured to notify a management controller regarding the air filter being clogged.

6. The information handling system of claim 5, wherein the management controller is configured to notify the other host information handling systems regarding the air filter being clogged.

7. A method comprising, in an information handling system that includes a chassis and a plurality of host information handling systems disposed within the chassis, each host information handling system including a host processor, an air mover, and an air filter, wherein a particular one of the plurality of host information handling systems further includes an airflow sensor configured to detect an amount of airflow associated with the air mover of the particular host information handling system, and wherein none of the other host information handling systems include corresponding airflow sensors:
in response to an airflow reading from the airflow sensor indicating that the air filter of the particular host information handling system is clogged, raising an air filter warning on the particular host information handling system; and
raising an air filter warning on the other host information handling systems.

8. The method of claim 7, wherein the airflow sensor is disposed within a removable bezel of the particular information handling system.

9. The method of claim 7, wherein the particular host information handling system is configured to notify the other host information handling systems directly regarding the air filter being clogged.

10. The method of claim 7, wherein the airflow sensor is further configured to detect a missing air filter.

11. The method of claim 7, wherein the particular host information handling system is configured to notify a management controller regarding the air filter being clogged.

12. The method of claim 11, wherein the management controller is configured to notify the other host information handling systems regarding the air filter being clogged.

13. An article of manufacture comprising a non-transitory, computer-readable medium having computer-executable instructions thereon that are executable by an information handling system that includes a chassis and a plurality of host information handling systems disposed within the chassis, each host information handling system including a host processor, an air mover, and an air filter, wherein a particular one of the plurality of host information handling systems further includes an airflow sensor configured to detect an amount of airflow associated with the air mover of the particular host information handling system, and wherein none of the other host information handling systems include corresponding airflow sensors, the instructions being executable for:
in response to an airflow reading from the airflow sensor indicating that the air filter of the particular host information handling system is clogged, raising an air filter warning on the particular host information handling system; and
raising an air filter warning on the other host information handling systems.

14. The article of manufacture of claim 13, wherein the airflow sensor is disposed within a removable bezel of the particular information handling system.

15. The article of manufacture of claim 13, wherein the particular host information handling system is configured to notify the other host information handling systems directly regarding the air filter being clogged.

16. The article of manufacture of claim 13, wherein the airflow sensor is further configured to detect a missing air filter.

17. The article of manufacture of claim 13, wherein the particular host information handling system is configured to notify a management controller regarding the air filter being clogged.

18. The article of manufacture of claim 17, wherein the management controller is configured to notify the other host information handling systems regarding the air filter being clogged.
